(19) United States
(12) Patent Application Publication
(10) Pub. No.: US 2006/0191746 A1
(43) Pub. Date: Aug. 31, 2006

(54) Oil-guiding shaft

(76) Inventors: Gabor Diosi, Friedrichshafen (DE); Josef Haupt, Friedrichshafen (DE); Martin Brehmer, Friedrichshafen (DE)

Correspondence Address: DAVIS & BUJOLD, P.L.L.C., 112 PLEASANT STREET, CONCORD, NH, 03301, US

(21) Appl. No.: 10/564,074

(22) PCT Filed: Jun. 28, 2004
(86) PCT No.: PCT/EP04/06962

§ 371 Date: Jan. 10, 2006

(30) Foreign Application Priority Data
Jul. 23, 2003 (DE) 10333432.7

(51) Int. Cl. F16N 7/36

(52) U.S. Cl. 184/6.18

(57) ABSTRACT

An oil-guiding shaft (1, 8) with an inner shaft space (35) coaxial with or axis-parallel to the longitudinal axis (34) of the shaft and with mechanisms arranged in the inner shaft space (35) for dividing the inner shaft space into at least two oil-guiding ducts separated from one another. To enable a plurality of oil-guiding ducts to be produced in a comparatively thin shaft (1, 8), the invention proposes that the ducts (3, 4, 5, 9, 10, 11, 12) are formed as ducts (3, 4, 5, 9, 10, 11, 12) open along their length on the inside wall (2) of the shaft (1) and separated and sealed from one another by a tube (6, 13) inserted into the inner shaft space (35).

This application is a national stage completion of PCT/EP2004/006962 filed Jun. 28, 2004 which claims priority from German Application Serial No. 103 33 432.7 filed Jul. 23, 2003.

### FIELD OF THE INVENTION

The invention concerns an oil-guiding shaft.

### BACKGROUND OF THE INVENTION

In many areas of technology, shafts are known through an axial bore of which a liquid or gaseous medium can be passed. Such shafts are, in particular, also used in transmissions in which hydraulic oil has to be delivered by a control pressure source to a transmission component which is to be actuated by this pressure control medium in as space-saving a manner as possible. Such transmission components are, as a rule, piston-cylinder arrangements by means of which clutches or brakes of the transmission can be actuated or by which the distance between the conical disks of a continuously variable belt transmission can be adjusted in order to change the transmission ratio.

If such a transmission shaft has a large enough diameter in relation to the torque to be transmitted, according to the prior art even two or more mutually parallel axial bores arranged next to one another in the shaft can be provided. The pressure control medium can be fed into and can emerge from the axial bores at their ends and/or through radial bores in the shaft which are in flow communication with the axial bores.

Particularly in relation to the comparatively thin shafts quite often used in the construction of transmission systems, it is often desired to provide these with more than just one axially directed bore to carry control pressure medium and/or lubricant, with the control pressure medium in the various ducts, as a rule, at different control pressures.

Since it is not possible in such thin shafts to form a plurality of axis-parallel bores without the risk of excessively weakening the material, according to the prior art a small hollow-cylindrical tube is inserted into a preferably coaxial bore in the shaft, whose axial hollow space forms a first pressure medium duct. By varying the outer diameter of such a small tube in relation to the wall of the axial bore surrounding the small tube, a further pressure medium duct is also provided, which by virtue of usually radially directed inlet or outlet bores is in pressure-transmitting communication with the actuators mentioned earlier.

Against this background, for example from DE 199 21 750 A1, a primary shaft of a continuously variable belt transmission with an axial bore is known, into which is pushed a tube rotationally sealed with respect to the axial bore, the tube itself having two longitudinal bores.

Furthermore from DE 196 03 598 A1, a secondary shaft of a continuously variable belt transmission is known in which a tube in an axial bore of the shaft is rotationally fixed to the transmission housing at one end, while the other end of the tube is held in a slide bearing arranged in the axial bore. In this structure too, the hollow-cylindrical inside space of the tube serves as a first control pressure duct, while a cylindrical annular space between the outer diameter of the tube and the inside diameter of the axial bore forms a second control pressure duct.

Finally, U.S. Pat. No. 6,015,359 A discloses a secondary shaft of a continuously variable belt transmission with an axial bore in which a special plug is firmly inserted. This special plug divides the axial bore of the secondary shaft into two chambers, while the plug itself is fed centrally with a control pressure medium via a small tube also inserted in the axial bore. This control pressure medium, which is under high pressure, can be passed into associated radial secondary shaft bores via three radial plug bores and a radially outer annular gap. In addition, three small axial bores are formed in the plug which maintain flow communication between the two chambers.

As is made clear by the above explanations, the creation of a plurality of oil-guiding ducts in thin shafts has until now been achieved only very imperfectly because their design structure is complex and manufacturing costs are therefore relatively high. There is thus a need to propose a shaft with a plurality of axial oil-guiding ducts or channels, which is of technically simple structure and can be produced inexpensively.

### SUMMARY OF THE INVENTION

According to the first solution, the oil-guiding shaft has a inner shaft space coaxial with or axis-parallel to the longitudinal axis of the shaft and means are arranged inside this inner shaft space for dividing the space into at least two oil-guiding ducts separate from one another. For this, it is provided that the ducts are formed as channels which, along their longitudinal extension, are at first open (similar to axial grooves) on the inside wall of the shaft and are then separated from and sealed with respect to one another by a tube inserted into the inside space of the shaft.

In an embodiment of this invention, the open ducts of the shaft are formed by bores which, in relation to their cross-sectional geometry, overlap. These open ducts can, for example, be created or formed in the shaft with the aid of a boring tool or by all-round press forming.

Regardless of the production method, it is also preferably provided that the at first still open ducts are formed with circular curved cross-sections. Furthermore, it can be appropriate for the open ducts to be arranged in the shaft in such a manner that their longitudinal axes lie in a notional plane.

In another variant of the invention, it can in contrast be provided that at least two of the at first still open ducts are arranged relative to another open duct in such a manner that their three longitudinal axes do not lie in the same notional plane.

According to the second solution of the technical problem addressed by the invention, the oil-guiding shaft is again provided with a hollow-cylindrical inner shaft space coaxial with or axis-parallel to the longitudinal axis of the shaft with means arranged in the inner shaft space to divide it into at least two ducts separated from one another. In contrast to the technical solution first described, in this case a profiled tube is arranged in the hollow-cylindrical inner shaft space, whose peripheral surface geometry is not circular so that, with the opposed areas of the shaft's inside wall, the desired channels or ducts are formed.

Regardless of whether the shaft is formed according to the first or the second technical solution, such shafts can have a number of advantageous design features.

For example, it can be provided that at least one radial lubricant bore is formed in the shaft, which leads from a lubricant source to the tube arranged inside the shaft's inner space.

Moreover, it is advantageous for the tube to have a connection area at least at one of its ends, by means of which it is supported and/or mounted on the wall of the shaft's inner space and for the oil-guiding ducts to be sealed with respect to one another.

As regards the geometry of the tube inserted into the shaft's inner space, it can be provided that this has a cylindrical, three-sides, star-shaped or rectangular corresponding geometry with an at least partially circular outer periphery. By virtue of this at least partly circular outer periphery, the tube rests in a pressure-tight way against the wall of the shaft's inner space, forming the ducts.

The insert in the shaft's inner space can be made either as a hollow section or as a solid section. A tube made as a hollow section, however, has the advantage that its inner space can be used within the shaft's inner space as one of the ducts for the oil.

Finally, with such a shaft it is considered advantageous to have bores leading radially to the ducts, through which the oil can be fed into and can emerge from the ducts.

### BRIEF DESCRIPTION OF THE DRAWINGS

The invention will now be described, by way of example, with reference to the accompanying drawings in which example embodiments of the two shafts are illustrated:

FIG. 1 is a longitudinal cross-section through a transmission shaft, with axial oil-guiding ducts formed in the central area;

FIG. 2 is a cross-section through the shaft of FIG. 1 in the central area, but without an inserted tube;

FIG. 3 is a cross-section through the shaft as in FIG. 2, but with an inserted tube;

FIG. 4 is a cross-section through another shaft with an inserted tube

FIG. 5 is a longitudinal section through another transmission shaft with axial oil-guiding ducts formed in the central area;

FIG. 6 is a cross-section through the shaft of FIG. 5 in the central area, with an inserted rectangular tube;

FIG. 7 is a cross-section through the shaft of FIG. 5, with an inserted star-shaped or three-sided tube, and

FIG. 8 is a cross-section through the shaft of FIG. 5, with an inserted star-shaped or three-sided solid section.

### DETAILED DESCRIPTION OF THE INVENTION

FIG. 1 is a longitudinal cross-section through a transmission shaft 1, in whose central area an axially extending hollow space is formed which, in what follows, will be referred to as a shaft's inner space 35. This inner space 35 of the shaft comprises three channels 3, 4, 5 which are still open in the pre-assembly condition and which, in the structure chosen for FIGS. 1 to 3, are formed as three circular bores arranged adjacent to one another and overlapping.

When a tube 6 is inserted into the inner shaft space 35, the tube separates the three channels 3, 4, 5 in a pressure-tight way so that they can, for example, be used as control pressure ducts independent of one another.

As is clear from FIG. 1, the tube 6 is inserted at one end 20 rotationally fixed in a blind hole of the shaft 1, while the other end 19 of the tube 6 is fitted into the central bore of the shaft 1.

Furthermore, it can be seen from the sectional representation through the shaft 1 in FIG. 1 that in the shaft 1 radial pressure medium inlet bores 37 and pressure medium outlet bores 38 and/or lubricant bores 7 are formed, which are in flow communication respectively with one of the ducts 3, 4, 5.

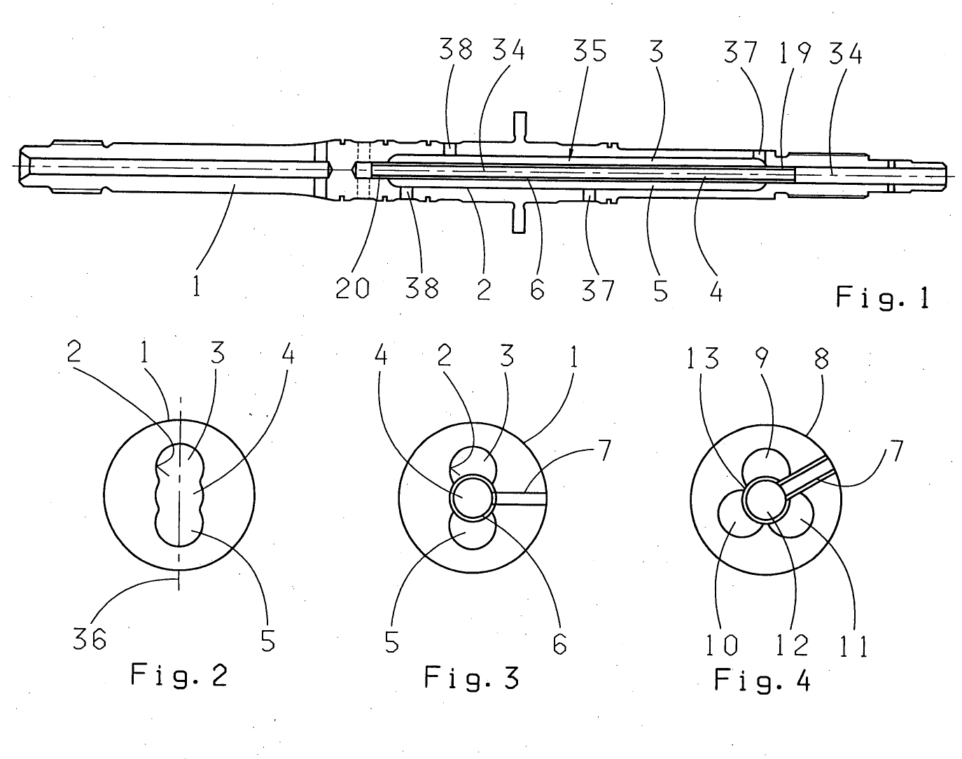

FIG. 2 now shows a cross-section of the shaft 1 in its central area. As can be seen from this representation, in the embodiment of the invention chosen here the ducts 3, 4, 5 are still open, so that these form the longitudinally extending inner shaft space 35 with a common inside wall 2. The ducts 3, 4, 5 are arranged in the shaft 1 in such manner that their longitudinal axes and a longitudinal axis 34 of the shaft itself lie in a notional plane 36 passing through the shaft. As shown by the cross-sectional representation in FIG. 3, the tube 6 inserted into this inner shaft space separates the ducts 3, 4, 5 from one another.

FIG. 4 now shows a cross-section through another shaft 8 whose inner shaft space is formed by four circular, overlapping and, in each case, still open channels 9, 10, 11 in the shaft material. By inserting a tube 13, the three radially outer channels 9, 10, 11 are separated axially and radially in a pressure-tight way from the tube 13 and from one another so that the tube 13 forms a fourth duct 12 when, as represented here, it is made as a hollow section.

As is clear from FIG. 4, in the comparatively thin shaft 8 a plurality of ducts (in this case four) 9, 10, 11, 12 can be formed, whose number depends only on the shaft's diameter and the necessary cross-section of the ducts.

In this variant of the invention too, at least one pressure medium inlet bore and a pressure medium outlet bore, respectively 37, 38, can be formed as well as a lubricant bore 7 and, if need be, a tube can be inserted into the lubricant bore 7 in order to prevent undesired leakage flows from the central duct into the two adjacent ducts.

The inner space 35 of the shaft 1, 8 can advantageously be produced by bores that overlap one another by press-forming an appropriate tube blank or even as a suitable casting.

The other solution for the technical problem addressed by the invention, as mentioned in the brief description of the invention, will be described below with reference to FIGS. 5 to 8. As shown by FIG. 5, a shaft 14 is largely comparable to the shaft 1, being provided with an inner shaft space 39 which is cylindrical and directed coaxially with the longitudinal axis 34 of the shaft 14.

Into this inner shaft space 39 is inserted a tube 16, which is connected rotationally fixed and in a pressure-tight way at both of its—in this area also cylindrical—axial ends 17, 18 to an inside wall 15 of the shaft 14. As the cross-sectional representation of FIG. 6 makes clear, in this case, in its central area the tube 16 has an essentially rectangular cross-section geometry, but two of the four sides of the rectangle have surfaces adapted to fit against the inside wall 15 of the shaft's inner space 39. This enables them to rest in contact with the inside wall 15 in a pressure-tight way.

In contrast, the other two sides of the rectangular section preferably have an axial cross-section reduction similar to two axially orientated longitudinal grooves, so that in this area two ducts 21, 22 opposite one another and with approximately lens-shaped cross-section geometry are formed in this area between the shaft's inside wall 15 and the outer wall of the tube. A third duct 23 is formed by the inside of the rectangular tube 16 itself.

As is also clear from FIG. 6, with this structure it can again be provided that the shaft 14 has at least one radial bore 33 which is used as a pressure medium inlet or outlet bore or as a lubricant inlet or outlet bore.

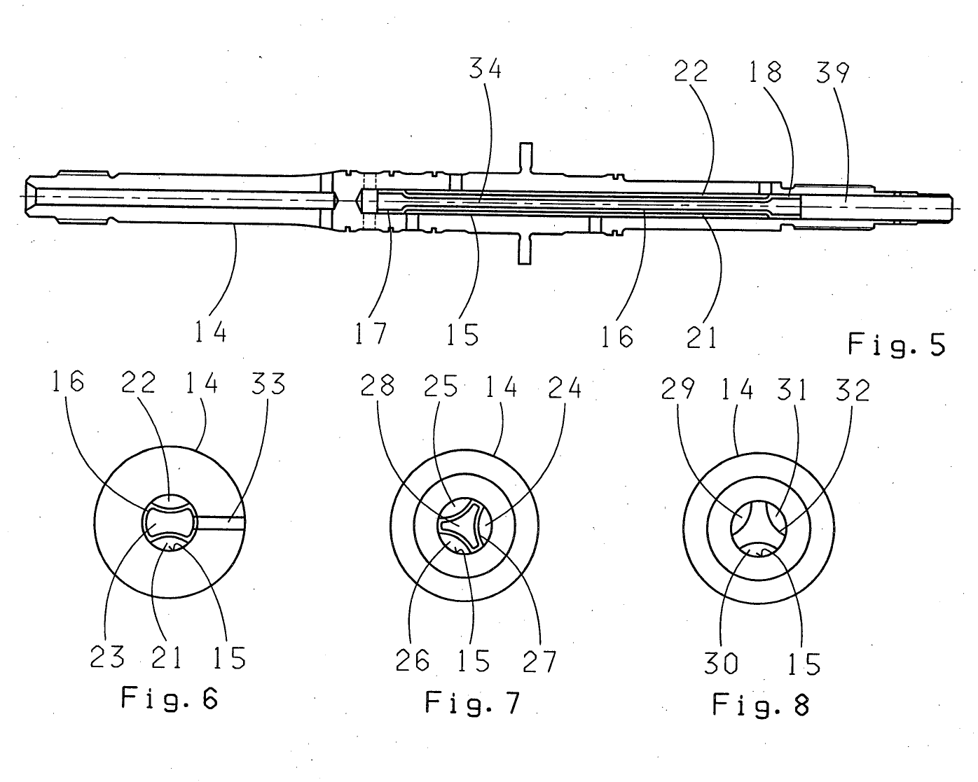

A glance at FIG. 7 shows that with the same coaxial inner shaft space 39 a tube 27 of perhaps star-shaped or three-sided cross-section can be inserted, by virtue of which, if a hollow section is chosen (as in the example embodiment illustrated), the shaft's inner space 39 can be divided into four ducts 24, 25, 27, 28 separated from one another in a pressure-tight way.

Finally, it can be seen from FIG. 8 that by inserting a very inexpensively produced three-sided solid section 32 into the inner space 39 of the shaft 14, a comparatively thin shaft 14 with a total of three oil-guiding ducts 29, 30, 31 can be produced with comparatively little manufacturing cost and effort.

Reference numerals

| | |
|---|---|
| 1 | shaft |
| 2 | wall of the inner shaft space of the shaft 1 |
| 3 | duct |
| 4 | duct |
| 5 | duct |
| 6 | tube |
| 7 | pressure medium inlet or outlet bores; lubricant bores |
| 8 | shaft |
| 9 | duct |
| 10 | duct |
| 11 | duct |
| 12 | duct |
| 13 | tube |
| 14 | shaft |
| 15 | wall of the inner shaft space of the shaft 14 |
| 16 | tube |
| 17 | connection area |
| 18 | connection area |
| 19 | connection area |
| 20 | connection area |
| 21 | duct |
| 22 | duct |
| 23 | duct |
| 24 | duct |
| 25 | duct |
| 26 | duct |
| 27 | tube |
| 28 | duct |
| 29 | duct |
| 30 | duct |
| 31 | duct |
| 32 | star-shaped section |
| 33 | pressure medium inlet or outlet bores; lubricant bores |
| 34 | longitudinal axis of shaft |
| 35 | inner space of shaft |
| 36 | plane containing longitudinal axes |
| 37 | inlet bore |
| 38 | outlet bore |
| 39 | inner space of shaft |

1-13. (canceled)

14. An oil-guiding shaft (1, 8), with an inner shaft space (35) coaxial with or axis-parallel to a longitudinal axis (34) of the shaft and a means arranged in the inner shaft space (35) for dividing the inner shaft space into at least two oil-guiding ducts separated from one another, the at least two oil-guiding ducts being formed as open ducts (3, 4, 5, 9, 10, 11, 12) open along a length on an inside wall (2) of the shaft (1, 8) and being separated and sealed from one another by a tube (6, 13) inserted into the inner shaft space (35), the open ducts (3, 4, 5, 9, 10, 11, 12) formed in the shaft (1, 8) are formed by non-concentric bores whose cross-sections overlap.

15. The shaft according to claim 14, wherein the open ducts (3, 4, 5, 9, 10, 11, 12) are formed by one of a boring tool and al-round press-forming of the shaft (1, 8).

16. The shaft according to claim 14, wherein the open ducts (3, 4, 5, 9, 10, 11, 12) have one of a circular and a groove-shaped cross-section geometry.

17. The shaft according to claim 14, wherein the open ducts (3, 4, 5, 9, 10, 11, 12) are arranged in the shaft (1, 8) such that longitudinal axes of the open ducts (3, 4, 5, 9, 10, 11, 12) all lie in a single plane (36).

18. The shaft according to claims 14, wherein at least two of the open ducts (10, 11) are arranged relative to a further open duct (9) such that a longitudinal axis of the first open duct and a longitudinal axis of the second open duct (11) lie in different planes.

19. The shaft according to claim 14, wherein at least one radial lubricant bore (7) is formed in the shaft (1, 8), which leads from one of a lubricant source and from a lubricant consumer to the tube (6, 13).

20. The shaft according to claim 14, wherein at least one end of the tube (6, 13) has a connection section (19, 20), with which the tube (6, 13) is one of supported and mounted on a wall (2, 15) of the inner shaft space and which seals the ducts (3 to 5; 9 to 12) from one another.

21. The shaft according to claim 14, wherein the tube (6, 13) has one of a cylindrical, a star-shaped, a three-sided and a rectangular cross-section geometry with an at least partially circular outer periphery.

22. The shaft according to claim 14, wherein the tube (6, 13) is formed as one of a hollow and a solid section.

23. The shaft according to claim 22, wherein an inside space of the tube (6, 13), formed as a hollow section, constitutes one of the ducts (4, 12).

24. The shaft according to claim 14, wherein the shaft (1, 8) has radial bores (37, 38) leading to the ducts (3 to 5; 9 to 12) through which a pressure medium can one of be fed and emerge from the ducts (3 to 5; 9 to 12).
